(19) United States
(12) Patent Application Publication
(10) Pub. No.: US 2025/0118292 A1
(43) Pub. Date: Apr. 10, 2025

(54) WORD-LEVEL END-TO-END NEURAL SPEAKER DIARIZATION WITH AUXNET

(71) Applicant: Google LLC, Mountain View, CA (US)

(72) Inventors: Yiling Huang, Edgewater, NJ (US); Weiran Wang, Iowa City, IA (US); Quan Wang, Hoboken, NJ (US); Guanlong Zhao, Long Island City, NY (US); Hank Liao, New York, NY (US); Han Lu, Redmond, WA (US)

(73) Assignee: Google LLC, Mountain View, CA (US)

(21) Appl. No.: 18/891,045

(22) Filed: Sep. 20, 2024

Related U.S. Application Data
(60) Provisional application No. 63/587,774, filed on Oct. 4, 2023.

(51) Int. Cl. G10L 15/06; G10L 15/07

(52) U.S. Cl. CPC G10L 15/063; G10L 15/07

(57) ABSTRACT

A method includes obtaining labeled training data including a plurality of spoken terms spoken during a conversation. For each respective spoken term, the method includes generating a corresponding sequence of intermediate audio encodings from a corresponding sequence of acoustic frames, generating a corresponding sequence of final audio encodings from the corresponding sequence of intermediate audio encodings, generating a corresponding speech recognition result, and generating a respective speaker token representing a predicted identity of a speaker for each corresponding speech recognition result. The method also includes training the joint speech recognition and speaker diarization model jointly based on a first loss derived from the generated speech recognition results and the corresponding transcriptions and a second loss derived from the generated speaker tokens and the corresponding speaker labels.

### CROSS REFERENCE TO RELATED APPLICATIONS

This U.S. patent application claims priority under 35 U.S.C. § 119 (e) to U.S. Provisional Application 63/587,774, filed on Oct. 4, 2023. The disclosure of this prior application is considered part of the disclosure of this application and is hereby incorporated by reference in its entirety.

### TECHNICAL FIELD

This disclosure relates to word-level end-to-end neural speaker diarization with auxnet.

### BACKGROUND

Speaker diarization is the process of partitioning an input audio stream into homogeneous segments according to speaker identity. In an environment with multiple speakers, speaker diarization answers the question “who is speaking when” and has a variety of applications including multimedia information retrieval, speaker turn analysis, audio processing, and automatic transcription of conversation speech to name a few. For example, speaker diarization involves the task of annotating speaker turns in a conversation by identifying that a first segment of an input audio stream is attributable to a first human speaker (without particularly identifying who the first human speaker is), and a second segment of the input audio stream is attributable to a different second human speaker (without particularly identify who the second human speaker is), a third segment of the input audio stream is attributable to the first human speaker, etc.

### SUMMARY

One aspect of the disclosure provides a computer-implemented method that when executed on data processing hardware causes the data processing hardware to perform operations of training a word-level end-to-end neural speaker diarization model with auxiliary networks. The operations include obtaining labeled training data that includes a plurality of spoken terms spoken during a conversation. Each respective spoken term is characterized by a corresponding sequence of acoustic frames and is paired with a corresponding transcription of the respective spoken term and a corresponding speaker label representing an identity of a speaker that spoke the respective spoken term during the conversation. For each respective spoken term of the plurality of spoken terms, the operations include: generating, by an initial stack of audio encoder layers of a joint speech recognition and speaker diarization model, a corresponding sequence of intermediate audio encodings from the corresponding sequence of acoustic frames; generating, by a remaining stack of audio encoder layers of the joint speech recognition and speaker diarization model, a corresponding sequence of final audio encodings from the corresponding sequence of intermediate audio encodings; generating a corresponding speech recognition result as output from a first decoder of the joint speech recognition and speaker diarization model configured to receive the corresponding sequence of final audio encodings; and, for each corresponding speech recognition result generated as output from the first decoder, generating a respective speaker token representing a predicted identity of a speaker as output from a second decoder of the joint speech recognition and speaker diarization model configured to receive the corresponding sequence of intermediate audio encodings. The operations also include training the joint speech recognition and speaker diarization model jointly based on a first loss derived from the generated speech recognition results and the corresponding transcriptions and a second loss derived from the generated speaker tokens and the corresponding speaker labels.

Implementations of the disclosure may include one or more of the following optional features. In some implementations, the joint speech recognition and speaker diarization model includes an automatic speech recognition (ASR) model and a diarization model. In these implementations, the ASR model includes an audio encoder and the first decoder and the diarization encoder includes a diarization encoder and the second decoder. The audio encoder includes the initial stack of audio encoder layers and the remaining stack of audio encoder layers. Here, the operations may further include generating, by the diarization encoder, a corresponding sequence of diarization encodings from the corresponding sequence of intermediate audio encodings. Generating the respective speaker token representing the predicted identity of the speaker includes generating the respective speaker token from the corresponding diarization encodings. The diarization encoder includes a memory unit configured to store previously generated diarization encodings.

In some examples, the first decoder includes a first joint network and a prediction network and the second decoder includes a second joint network and the prediction network shared with the first decoder. In these examples, each of the first joint network and the second joint network include a respective first projection layer, a respective linear layer, and a respective softmax layer. The respective speaker token may include at least one of a word-level speaker token, a wordpiece-level speaker token, and a grapheme-level speaker token. In some implementations, the operations further include generating the labeled training data by obtaining a set of single-speaker speech segments, concatenating two or more single-speaker speech segments from the set of single-speaker speech segments, and augmenting the concatenated two or more single-speaker speech segments.

In some examples, the operations further include generating the labeled training data by obtaining a human annotated transcription and corresponding audio data, generating a transcription for the corresponding audio data using a universal speech model, and replacing the one or more incorrectly labeled terms using the transcription generated by the universal speech model for the corresponding transcription. The human annotated transcription includes speaker labels and one or more incorrectly labeled terms. The operations may further include generating the labeled training data by receiving a conversational prompt, generating a conversational transcription based on the conversational prompt by a pre-trained large language model (LLM), and synthesizing the conversational transcription using a pre-trained text-to-speech (TTS) model.

Another aspect of the disclosure provides a system that includes data processing hardware and memory hardware storing instructions that when executed on the data processing hardware causes the data processing hardware to perform operations. The operations include obtaining labeled training data that includes a plurality of spoken terms spoken during a conversation. Each respective spoken term is characterized by a corresponding sequence of acoustic frames and is paired with a corresponding transcription of the respective spoken term and a corresponding speaker label representing an identity of a speaker that spoke the respective spoken term during the conversation. For each respective spoken term of the plurality of spoken terms, the operations include: generating, by an initial stack of audio encoder layers of a joint speech recognition and speaker diarization model, a corresponding sequence of intermediate audio encodings from the corresponding sequence of acoustic frames; generating, by a remaining stack of audio encoder layers of the joint speech recognition and speaker diarization model, a corresponding sequence of final audio encodings from the corresponding sequence of intermediate audio encodings; generating a corresponding speech recognition result as output from a first decoder of the joint speech recognition and speaker diarization model configured to receive the corresponding sequence of final audio encodings; and, for each corresponding speech recognition result generated as output from the first decoder, generating a respective speaker token representing a predicted identity of a speaker as output from a second decoder of the joint speech recognition and speaker diarization model configured to receive the corresponding sequence of intermediate audio encodings. The operations also include training the joint speech recognition and speaker diarization model jointly based on a first loss derived from the generated speech recognition results and the corresponding transcriptions and a second loss derived from the generated speaker tokens and the corresponding speaker labels.

Implementations of the disclosure may include one or more of the following optional features. In some implementations, the joint speech recognition and speaker diarization model includes an automatic speech recognition (ASR) model and a diarization model. In these implementations, the ASR model includes an audio encoder and the first decoder and the diarization encoder includes a diarization encoder and the second decoder. The audio encoder includes the initial stack of audio encoder layers and the remaining stack of audio encoder layers. Here, the operations may further include generating, by the diarization encoder, a corresponding sequence of diarization encodings from the corresponding sequence of intermediate audio encodings. Generating the respective speaker token representing the predicted identity of the speaker includes generating the respective speaker token from the corresponding diarization encodings. The diarization encoder includes a memory unit configured to store previously generated diarization encodings.

In some examples, the first decoder includes a first joint network and a prediction network and the second decoder includes a second joint network and the prediction network shared with the first decoder. In these examples, each of the first joint network and the second joint network include a respective first projection layer, a respective linear layer, and a respective softmax layer. The respective speaker token may include at least one of a word-level speaker token, a wordpiece-level speaker token, and a grapheme-level speaker token. In some implementations, the operations further include generating the labeled training data by obtaining a set of single-speaker speech segments, concatenating two or more single-speaker speech segments from the set of single-speaker speech segments, and augmenting the concatenated two or more single-speaker speech segments.

In some examples, the operations further include generating the labeled training data by obtaining a human annotated transcription and corresponding audio data, generating a transcription for the corresponding audio data using a universal speech model, and replacing the one or more incorrectly labeled terms using the transcription generated by the universal speech model for the corresponding transcription. The human annotated transcription includes speaker labels and one or more incorrectly labeled terms. The operations may further include generating the labeled training data by receiving a conversational prompt, generating a conversational transcription based on the conversational prompt by a pre-trained large language model (LLM), and synthesizing the conversational transcription using a pre-trained text-to-speech (TTS) model.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system that executes a joint speech recognition and speaker diarization model.

FIG. 2 is a schematic view of an example automatic speech recognition model.

FIGS. 3A and 3B are schematic views of exemplary joint networks of the joint speech recognition and speaker diarization model.

FIG. 4 is a schematic view of an example training process for training the joint speech recognition and speaker diarization model.

FIGS. 5A-5C are schematic views of generating labeled training data used to train the joint speech recognition and speaker diarization model.

FIG. 6 is a flowchart of an example arrange of operations for a computer-implemented method of training a word-level end-to-end neural speaker diarization model with auxiliary networks.

FIG. 7 is a schematic view of an example computing device that may be used to implement the systems and methods described herein.

Like reference symbols in the various drawings indicate like elements.

### DETAILED DESCRIPTION

Automatic speech recognition (ASR) systems generally rely on speech processing algorithms that assume only one speaker is present in a given input audio signal. An input audio signal that includes a presence of multiple speakers can potentially disrupt these speech processing algorithms, thereby leading to inaccurate speech recognition results output by the ASR systems. As such, speaker diarization is the process of segmenting speech from a same speaker in a larger conversation not to specifically determine who is talking (speaker recognition/identification), but rather, determine when someone is speaking. Put another way, speaker diarization includes a series of speaker recognition tasks with short utterances that determines whether two segments of a given conversation were spoken by the same speaker or different speakers, and is repeated for all segments of the conversation. Accordingly, speaker diarization detects speaker turns from a conversation that includes multiple speakers. As used herein, the term ‘speaker turn’ refers to the transition from one individual speaking to a different individual speaking in a larger conversation.

Existing speaker diarization systems generally include multiple relatively independent components, such as, without limitation, a speech segmentation module, an embedding extraction module, and a clustering module. The speech segmentation module is generally configured to remove non-speech parts from an input utterance and divide the entire input utterance into fixed-length segments. Although dividing the input utterance into fixed-length segments is easy to implement, oftentimes, it is difficult to find a good segment length. That is, long fixed-length segments may include several speaker turns, while short segments include an insufficient number of speaker turns. The embedding extraction module is configured to extract, from each segment, a corresponding speaker-discriminative embedding. The speaker-discriminative embedding may include i-vectors or d-vectors. The clustering modules are tasked with determining the number of speakers present in the input utterance and assigning speaker identities (i.e., labels) to each segment. These clustering modules may use popular clustering algorithms that include Gaussian mixture models, mean shift clustering, agglomerative hierarchical clustering, k-means clustering, links clustering, and spectral clustering.

Implementations herein are directed towards methods and systems that perform word-level end-to-end speaker diarization with auxiliary networks (auxnet). In particular, an example training process trains a joint speech recognition and speaker diarization model by obtaining labeled training data that includes a plurality of spoken terms spoken during a conversation (e.g., a conversation between two or more speakers). Here, each respective spoken term from the training data is paired with a corresponding transcription (e.g., ground-truth transcription) of the respective spoken term and a corresponding speaker label (e.g., ground-truth speaker label) representing an identity of a speaker that spoke the respective spoken term during the conversation. The joint speech recognition and speaker diarization model includes an initial stack of audio encoder layers, a remaining stack of the audio encoder layers, a first decoder, and a second decoder. For each respective spoken term in the training data, the training process generates a corresponding sequence of intermediate audio encodings using the initial stack of the audio encoder layers, a corresponding sequence of final audio encodings using the remaining stack of the audio encoder layers, and a respective speaker token, a speech recognition result using the first decoder, and a speaker token using the second decoder. Thereafter, the training process trains the joint speech recognition and speaker diarization model jointly based on a first loss derived from the generated speech recognition results and the corresponding transcriptions and a second loss derived from the generated speaker tokens and the corresponding speaker labels. Moreover, because limited annotated (i.e., labeled) training data is available for speaker diarization, the training process may generate and/or augment additional training data for training the joint speech recognition and speaker diarization model.

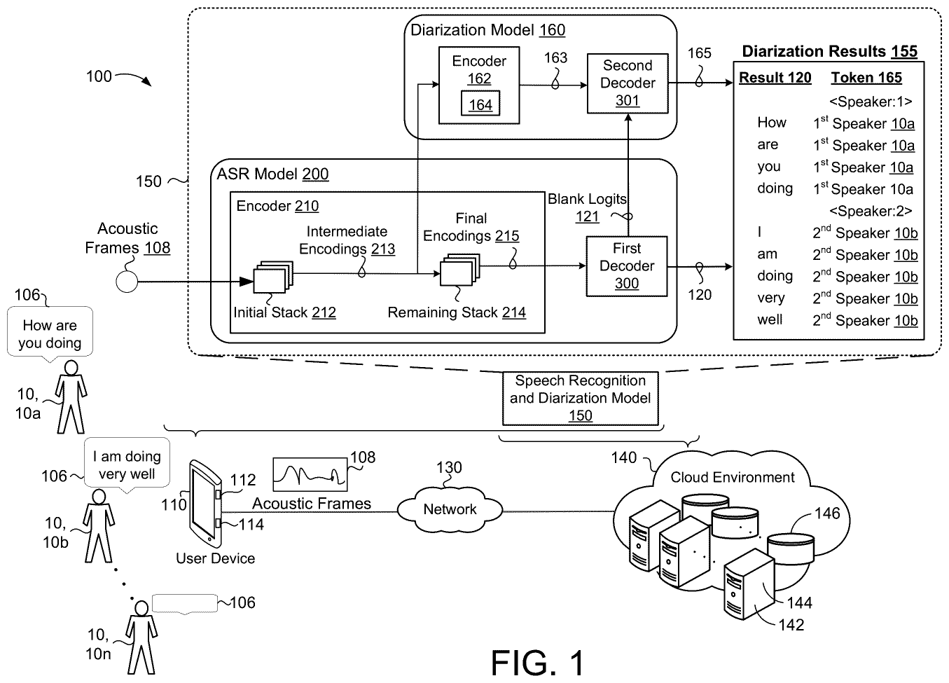

Referring to FIG. 1, a system 100 includes a user device 110 capturing speech utterances 106 spoken by multiple speakers (e.g., users) 10, 10a-n during a conversation and communicating with a remote system 140 via a network 130. The remote system 140 may be a distributed system (e.g., cloud computing environment) having scalable/elastic resources 142. The resources 142 include computing resources 144 (e.g., data processing hardware) and/or storage resources 146 (e.g., memory hardware). In some implementations, the user device 110 and/or the remote system 140 executes a joint speech recognition and speaker diarization model 150 that is configured to receive a sequence of acoustic frames 108 that corresponds to captured speech utterances 106 spoken by the multiple speakers 10 during the conversation and generate, at each of a plurality of output steps, speech recognition results (e.g., speech recognition hypotheses or transcriptions) 120 corresponding to the captured speech utterances 106 and diarization results 155. As will become apparent, the speech recognition results 120 indicate “what” was spoken during the conversation and the diarization results 155 indicate “who” spoke each word/wordpiece of the speech recognition results 120. Notably, the diarization results 155 include word-level results that represent who spoke each word/wordpiece rather than frame-level results that represent who was speaking during each frame of the sequence of acoustic frames 108.

The user device 110 includes data processing hardware 112 and memory hardware 114. The user device 110 may include an audio capture device (e.g., microphone) for capturing and converting the speech utterances 106 (also referred to as simply “utterances 106”) from the multiple speakers 10 into the sequence of acoustic frames 108 (e.g., input audio data). In some implementations, the user device 110 is configured to execute a portion of the joint speech recognition and speaker diarization model 150 locally (e.g., using the data processing hardware 112) while a remaining portion of the joint speech recognition and speaker diarization model 150 executes on the cloud computing environment 140 (e.g., using data processing hardware 144). Alternatively, the joint speech recognition and speaker diarization model 150 may execute entirely on the user device 110 or cloud computing environment 140. The user device 110 may be any computing device capable of communicating with the cloud computing environment 140 through the network 130. The user device 110 includes, but is not limited to, desktop computing devices and mobile computing devices, such as laptops, tablets, smart phones, smart speakers/displays, smart appliances, internet-of-things (IoT) devices, and wearable computing devices (e.g., headsets and/or watches).

In the example shown, the multiple speakers 10 and the user device may be located within an environment (e.g., a room) where the user device 110 is configured to capture and convert the speech utterances 106 spoken by the multiple speakers 10 into the sequence of acoustic frames 108. For instance, the multiple speakers 10 may correspond to co-workers having a conversation during a meeting and the user device 110 may record and convert the speech utterances 106 into the sequence of acoustic frames 108. In turn, the user device 110 may provide the sequence of acoustic frames 108 to the joint speech recognition and speaker diarization model 150 to generate speech recognition results 120 and diarization results 155.

In some examples, at least a portion of the speech utterances 106 conveyed in the sequence of acoustic frames 108 are overlapping such that, at a given instant in time, two or more speakers 10 are speaking simultaneously. Notably, a number N of the multiple speakers 10 may be unknown when the sequence of acoustic frames 108 are provided as input to the joint speech recognition and speaker diarization model 150 whereby the joint speech recognition and speaker diarization model 150 predicts the number N of the multiple speakers 10. In some implementations, the user device 110 is remotely located from the one or more of the multiple speakers 10. For instance, the user device 110 may include a remote device (e.g., network server) that captures speech utterances 106 from the multiple speakers 10 that are participants in a phone call or video conference. In this scenario, each speaker 10 would speak into their own user device 110 (e.g., phone, radio, computer, smartwatch, etc.) that captures and provides the speech utterances 106 to the remote user device for converting the speech utterances 106 into the sequence of acoustic frames 108. Of course in this scenario, the speech utterances 106 may undergo processing at each of the user devices 110 and be converted into a corresponding sequence of acoustic frames 108 that are transmitted to the remote user device which may additionally process the sequence of acoustic frames 108 provided as input to the joint speech recognition and speaker diarization model 150.

In the example shown, the joint speech recognition and speaker diarization model 150 includes an automatic speech recognition (ASR) model 200 that has an audio encoder 210 and a first decoder 300, and a diarization model 160 that has a diarization encoder 162 and a second decoder 301. Notably, the first decoder 300 is independent and separate from the second decoder 301. That is, the first decoder 300 includes a respective set of parameters and the second decoder 301 includes a different respective set of parameters. Here, only two speakers (e.g., a first speaker 10, 10a and a second speaker 10, 10b) are participating in the conversation for the sake of clarity only, as it is understood that any number of speakers 10 may speak during the conversation. In the example shown, the first speaker 10a speaks “how are you doing” and the second speaker 10b responds by speaking “I am doing very well.” The ASR model 200 is configured to generate the speech recognition results 120 representing “what” was spoken by the multiple speakers 10 during the conversation based on the sequence of acoustic frames 108.

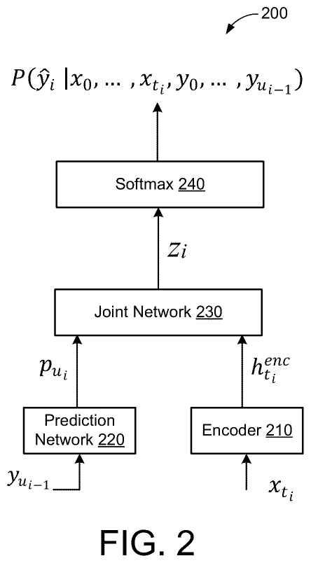

Referring now to FIG. 2, in some implementations, the ASR model 200 includes a Recurrent Neural Network-Transducer (RNN-T) model architecture which adheres to latency constraints with interactive applications. The use of the RNN-T model architecture is exemplary only, as the ASR model 200 may include other architectures such as transformer-transducer and conformer-transducer model architectures, among others. The RNN-T model 200 provides a small computational footprint and utilizes less memory requirements than conventional ASR architectures, making the RNN-T model architecture suitable for performing speech recognition entirely on the user device 110 (e.g., no communication with a remote server is required). The RNN-T model 200 includes an encoder network (e.g., audio encoder) 210, a prediction network 220, and a joint network 230. The encoder network 210, which is roughly analogous to an acoustic model (AM) in a traditional ASR system, includes a stack of self-attention layers (e.g., Conformer or Transformer layers) or a recurrent network of stacked Long Short-Term Memory (LSTM) layers. For instance, audio encoder 210 reads a sequence of d-dimensional feature vectors (e.g., acoustic frames 108 (FIG. 1) x=(x₁, x₂, . . . , x_{T}), where xₜ∈ [symbol] _{d}, and produces at each output step a higher-order feature representation (e.g., audio encoding). This higher-order feature representation is denoted as h₁^{enc}, . . . , h_{T}^{enc}.

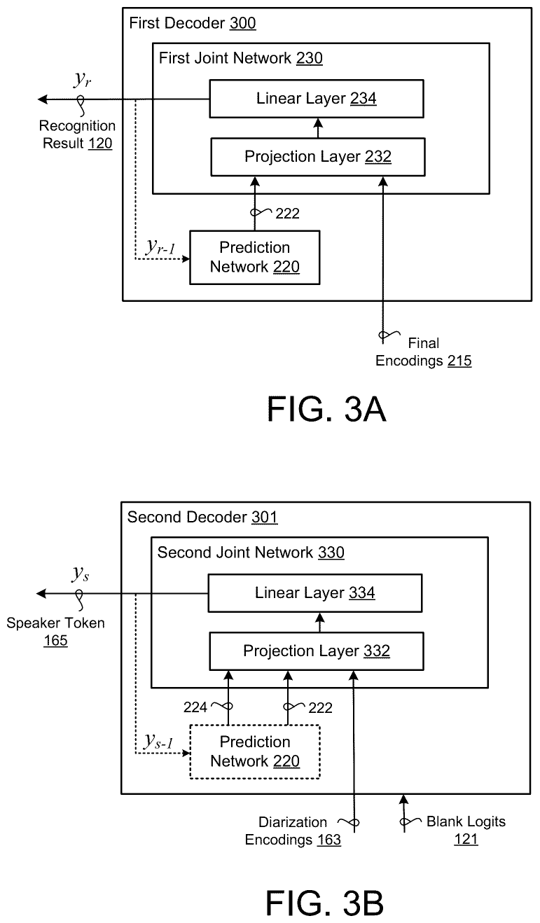

Similarly, the prediction network 220 is also an LSTM network, which, like a language model (LM), processes the sequence of non-blank symbols output by a final Softmax layer 240 so far, y₀, . . . , yᵤᵢ₋₁, into a dense representation pᵤ_{ᵢ}. Described in greater detail with reference to FIG. 3A, the prediction network 220 and the joint network 230 may collectively form the first decoder 300 of FIG. 1 that includes an RNN-T architecture. Finally, with the RNN-T model architecture, the representations produced by the encoder and prediction/decoder networks 210, 220 are combined by the joint network 230. The prediction network 220 may be replaced by an embedding look-up table to improve latency by outputting looked-up sparse embeddings in lieu of processing dense representations. The joint network 230 then predicts P(yᵢ|xₜ_{ᵢ}, y₀, . . . , yᵤ_{ᵢ₋₁}), which is a distribution over the next output symbol. Stated differently, the joint network 230 generates, at each output step (e.g., time step), a probability distribution over possible speech recognition hypotheses. Here, the “possible speech recognition hypotheses” correspond to a set of output labels each representing a symbol/character in a specified natural language. For example, when the natural language is English, the set of output labels may include twenty-seven (27) symbols, e.g., one label for each of the 26-letters in the English alphabet and one label designating a space. Accordingly, the joint network 230 may output a set of values indicative of the likelihood of occurrence of each of a predetermined set of output labels. This set of values can be a vector and can indicate a probability distribution over the set of output labels. In some cases, the output labels are graphemes (e.g., individual characters, and potentially punctuation and other symbols), but the set of output labels is not so limited. For example, the set of output labels can include wordpieces, phonemes, and/or entire words, in addition to or instead of graphemes. The output distribution of the joint network 230 can include a posterior probability value for each of the different output labels. Thus, if there are 100 different output labels representing different graphemes or other symbols, the output yᵢ of the joint network 230 can include 100 different probability values, one for each output label. The probability distribution can then be used to select and assign scores to candidate orthographic elements (e.g., graphemes, wordpieces, and/or words) in a beam search process (e.g., by the Softmax layer 240) for determining the speech recognition result (e.g., transcription) 120 (FIG. 1).

The Softmax layer 240 may employ any technique to select the output label/symbol with the highest probability in the distribution as the next output symbol predicted by the RNN-T model 200 at the corresponding output step. In this manner, the RNN-T model 200 does not make a conditional independence assumption, rather the prediction of each symbol is conditioned not only on the acoustics, but also on the sequence of labels output so far. The RNN-T model 200 does assume an output symbol is independent of future acoustic frames 108, which allows the RNN-T model to be employed in the streaming fashion, the non-streaming fashion, or some combination thereof.

In some examples, the audio encoder 210 of the RNN-T model includes a plurality of multi-head (e.g., 8 heads) self-attention layers. For example, the plurality of multi-head self-attention layers may include Conformer layers (e.g., Conformer-encoder), transformer layers, performer layers, convolution layers (including lightweight convolution layers), or any other type of multi-head self-attention layers. The plurality of multi-head self-attention layers may include any number of layers, for instance, 16 layers. Moreover, the audio encoder 210 may operate in the streaming fashion (e.g., the audio encoder 210 outputs initial higher-order feature representations as soon as they are generated), in the non-streaming fashion (e.g., the audio encoder 210 outputs subsequent higher-order feature representations by processing additional right-context to improve initial higher-order feature representations), or in a combination of both the streaming and non-streaming fashion.

Referring back to FIG. 1, in some examples, the audio encoder 210 includes a stack of audio encoder layers 212, 214 having multi-head self-attention layers (e.g., conformer, transformer, convolutional, or performer layers) or a recurrent network of Long Short-Term Memory (LSTM) layers. For instance, the audio encoder 210 receives, as input, the sequence of acoustic frames 108 and generates, at each of the plurality of output steps, corresponding audio encoding 213, 215. More specifically, an initial stack of audio encoder layers 212 generates, at each output step, a corresponding sequence of intermediate audio encodings 213 from the sequence of acoustic frames 108. Thereafter, a remaining stack of the audio encoder layers 214 generates, at each output step, a corresponding sequence of final audio encodings 215 from the sequence of intermediate audio encodings 213. For example, the stack of audio encoder layers 212, 214 may include sixteen (16) conformer layers where the initial stack of audio encoder layers 212 (e.g., four (4) conformer layers) generates the corresponding sequence of intermediate audio encodings 213 from the sequence of acoustic frames 108 and the remaining stack of audio encoder layers 214 (e.g., the remaining twelve (12) conformer layers) generates the corresponding sequence of final audio encodings 215 from the corresponding sequence of intermediate audio encodings 213.

Notably, some information is discarded (e.g., background noise) as the initial stack of audio encoder layers 212 generates the sequence of intermediate audio encodings 213, but speaker characteristic information is maintained. Here, speaker characteristic information refers to the speaking traits or style of a particular user, for example, prosody, accent, dialect, cadence, pitch, etc. However, after generating the intermediate audio encodings 213, the speaker characteristic information may also be discarded as the remaining stack of audio encoder layers 214 generates the sequence of final audio encodings 215. That is, because the ASR model 200 is configured to predict “what” was spoken, the remaining stack of audio encoder layers 214 may filter out the speaker characteristic information (e.g., indicating voice characteristics of the particular user speaking) because voice characteristics pertaining to particular speakers are not needed to predict “what” was spoken and are only relevant when predicting “who” is speaking.

On the other hand, the diarization model 160 may leverage the speaker characteristic information to improve accuracy of predicting “who is speaking when,” because voice characteristics pertaining to particular speakers is helpful information when identifying who is speaking. Thus, because the sequence of intermediate audio encodings 213 includes the speaker characteristic information from the sequence of acoustic frames 108 (e.g., that may be subsequently discarded by the remaining stack of audio encoder layers 214), the intermediate audio encodings 213 advantageously enable the diarization model 160 to more accurately predict who is speaking each term (e.g., word, wordpiece, grapheme, etc.) of the speech recognition results 120. The first decoder 300 of the ASR model 200 is configured to receive, as input, the sequence of final audio encodings 215 generated by the remaining stack of audio encoder layers 214 and generate, at each of the plurality of output steps, a corresponding speech recognition result 120. The speech recognition result 120 may include a probability distribution over possible speech recognition hypotheses (e.g., words, wordpieces, graphemes, etc.) whereby the diarization results 155 are word-level, wordpiece-level, or grapheme-level results. In some examples, the speech recognition results 120 include blank logits 121 denoting that no terms are currently being spoken at the corresponding output step. As will become apparent, the first decoder 300 may output the blank logits 121 and/or the speech recognition results 120 (not shown) to the second decoder 301 such that the second decoder 301 only outputs speaker tokens when the first decoder 300 outputs non-blank speech recognition hypotheses 120.

Referring now to FIG. 3A, the decoder 300 may include a RNN-T architecture having the first joint network 230 and the prediction network 220. The first decoder 300 uses the first joint network 230 to combine the sequence of final audio encodings 215 generated by the remaining stack of audio encoder layers 214 (FIG. 1) and an audio embedding output 222 generated by the prediction network 220 for the previous prediction yᵣ₋₁ to generate the speech recognition result 120. The speech recognition result 120 may be a probability distribution, P (yᵢ|yᵢ₋₁, . . . , y₀, x), over the current sub-word unit, yᵢ, given the sequence of the N previous non-blank symbols previous units, {yᵢ₋₁, . . . , y_{i-N}}, and the input of the sequence of final audio encodings 215. In some examples, the first joint network 230 includes a first projection layer 232 that applies a projection and addition activation to combine the sequence of final audio encodings 215 and the audio embedding output 222, and a first linear layer 234 that applies a hyperbolic tangent function (Tan h) and a linear activation on the output of the first projection layer 232 to generate the speech recognition result 120. Although not illustrated, in some examples, the first decoder 300 includes a Softmax layer (e.g., Softmax layer 240 (FIG. 2)) that receives the output of the first decoder 300. In some implementations, the Softmax layer is separate from the first decoder 300 and processes the output, yᵣ, from the first decoder 300. Thus, the output of the Softmax layer is then used in a beam search process to select orthographic elements to generate the speech recognition result 120. In some implementations, the Softmax layer is integrated with the first decoder 300, such that the output yᵣ of the first decoder 300 represents the output of the Softmax layer.

Referring back to FIG. 1, the diarization model 160 is configured to generate, for each speech recognition result 120 generated by the first decoder 300 of the ASR model 200, a respective speaker token 165 representing a predicted identity of a speaker 10 from the multiple speakers 10 speaking during the conversation. Thus, the respective speaker tokens 165 generated by the diarization model 160 are word-level, wordpiece-level, or grapheme-level in connection with the ASR model 200 generating word-level, wordpiece-level, or grapheme-level speech recognition results 120, respectively. In particular, the diarization encoder 162 of the diarization model 160 receives, as input, the sequence of intermediate audio encodings 213 generated by the initial stack of audio encoder layers 212 and generates, at each of the plurality of output steps, a corresponding sequence of diarization encodings 163 from the sequence of the intermediate audio encodings 213. Notably, as discussed above, the sequence of intermediate audio encodings 213 may retain speaker characteristic information associated with the speaker 10 that is currently speaking to predict the identity of the speaker 10.

Moreover, the diarization encoder 162 includes a memory unit 164 that stores the previously generated diarization encodings 163 generated at prior output steps during the conversation. The memory unit 164 may include the memory hardware 114 from the user device 110 and/or the memory hardware 146 from the cloud computing environment 140. In particular, the diarization model 160 may include a recurrent neural network that has a stack of long short-term memory (LSTM) layers or a stack of multi-headed self-attention layers (e.g., conformer layers or transformer layers). Here, the stack of LSTM layers or multi-head self-attention layers act as the memory unit 164 and store the previously generated diarization encodings 163. As such, the diarization encoder 162 may generate, for a current output step, a corresponding diarization encoding 163 based on the previous diarization encodings 163 generated for the preceding output steps during the conversation. Advantageously, using the previous diarization encodings 163 provides the diarization model 160 more context in predicting which particular speaker 10 is currently speaking based on previous words the particular speaker 10 may have spoken during the conversation. In some implementations, the diarization model 160 includes a plurality of diarization encoders 162 (e.g., K number of diarization encoders) (not shown) whereby K is equal to the number speakers 10 speaking during the conversation. Stated differently, each diarization encoder 162 of the K number of diarization encoders 162 may be assigned to a particular one of the speakers 10 from the conversation. Moreover, each diarization encoder 162 of the K number of diarization encoders 162 is configured to receive a Kth intermediate audio encoding 213 from the audio encoder 210. Here, each of the Kth intermediate audio encodings 213 is associated with a respective one of the speakers 10 and is output to a corresponding diarization encoder 162 associated with the respective one of the speakers 10.

Thereafter, the second decoder 301 receives the sequence of diarization encodings 163 generated by the diarization encoder 162 and generates, for each respective speech recognition result 120 output by the ASR model 200, the respective speaker token 165 representing a predicted identity of the speaker 10 from the multiple speakers 10 that spoke the corresponding term from the speech recognition results 120. That is, the ASR model 200 may output speech recognition results 120 at each output step of the plurality of output steps such that the speech recognition results 120 include blank logits 121 where no speech is currently present. In contrast, the second decoder 301 is configured to receive the blank logits 121 and/or speech recognition results 120 (not shown) from the ASR model 200 whereby the second decoder 301 only generates speaker tokens 165 when the ASR model 200 generates speech recognition results 120 that include a spoken term. For example, for a conversation that includes ten (10) words, the second decoder 301 generates a corresponding ten (10) speaker tokens 165 (e.g., one speaker token for each word recognized by the ASR model 200).

Referring now to FIG. 3B, the second decoder 301 may include a RNN-T architecture having a second joint network 330. Optionally, the second decoder 301 may include the prediction network 220 (e.g., denoted by dotted lines) that is shared with the first decoder 300 (FIG. 3A). The second decoder 301 uses the second joint network 330 to process the sequence of diarization encodings 163 generated by the diarization encoder 162 of the diarization model 160 (FIG. 1) to generate the speaker token 165. When the second decoder 301 includes the prediction network 220, the second joint network 330 combines the sequence of diarization encodings 163 with the audio embedding output 222 generated by the prediction network 220 for the previous prediction yᵣ₋₁ (FIG. 3A) and/or a token embedding output 224 generated by the prediction network 220 for the previous prediction yₛ₋₁ to generate the speaker token 165. In some examples, the second joint network 330 includes a second projection layer 332 that applies a projection and addition activation on the sequence of diarization encodings 163, the audio embedding output 222, and/or the token embedding output 224 and a second linear layer 334 that applies a hyperbolic tangent function (Tan h) and a linear activation on the output of the second projection layer 332 to generate the speaker token 165. Although not illustrated, the second decoder 301 may include a Softmax layer that receives the output of the second decoder 301. In some implementations, the Softmax layer is separate from the second decoder 301 and processes the output, yₛ, from the second decoder 301. Thus, the output of the Softmax layer is then used in a beam search process to select orthographic elements to generate the speaker token 165. In some implementations, the Softmax layer is integrated with the second decoder 301, such that the output yₛ of the first decoder 300 represents the output of the Softmax layer. Moreover, the second decoder 301 may receive the blank logits 121 from the ASR model 200 (FIG. 1) such that the second decoder 301 only outputs speaker tokens 165 for non-blank logits.

Referring back to FIG. 1, the joint speech recognition and speaker diarization model 150 combines the speech recognition results 120 generated by the ASR model 200 and the speaker tokens 165 generated by the diarization model 160 to generate the diarization results 155. That is, the diarization results 155 indicate, for each respective term (e.g., word, wordpiece, and/or grapheme) of the speech recognition results 120 generated by the ASR model 200, an identity of the corresponding speaker 10 from the multiple speakers 10 that spoke the respective term of the speech recognition results 120. Thus, as the speech recognition results 120 include words, wordpieces, and/or graphemes, the diarization results 155 are similarly word-level, wordpiece-level, and/or grapheme-level, respectively.

Continuing with the example shown, the ASR model 200 recognizes word-level speech recognition results 120 of “How are you doing I am doing very well” and the diarization model 160 generates a corresponding speaker token 165 for each spoken word from the speech recognition results 120. In this example, the corresponding speaker tokens 165 indicate that the first speaker 10a spoke the words “How are you doing” and the second speaker 10b spoke the words “I am doing very well” during the conversation. Thus, by combining the speech recognition results 120 and the speaker tokens 165, the joint speech recognition and speaker diarization model 150 generates word-level diarization results 155 because the corresponding speech recognition results 120 output by the ASR model 200 are word-level. In some examples, the diarization model 160 the speaker token 165 includes speaker turn labels denoting the transition between speakers talking. For instance, the diarization results 155 include the speaker token 165 including the speaker turn label “<Speaker: 1>” before the first speaker 10a starts speaking and the speaker token 165 including the speaker turn label “<Speaker: 2>” as the second speaker 10b starts speaking. The diarization results 155 may be transmitted to the user devices 110 and displayed by graphical user interfaces of the user devices 110 for the speakers 10. Moreover, the diarization results 155 may be stored at the memory hardware 114, 146 for subsequent retrieval by one or more of the user devices 110.

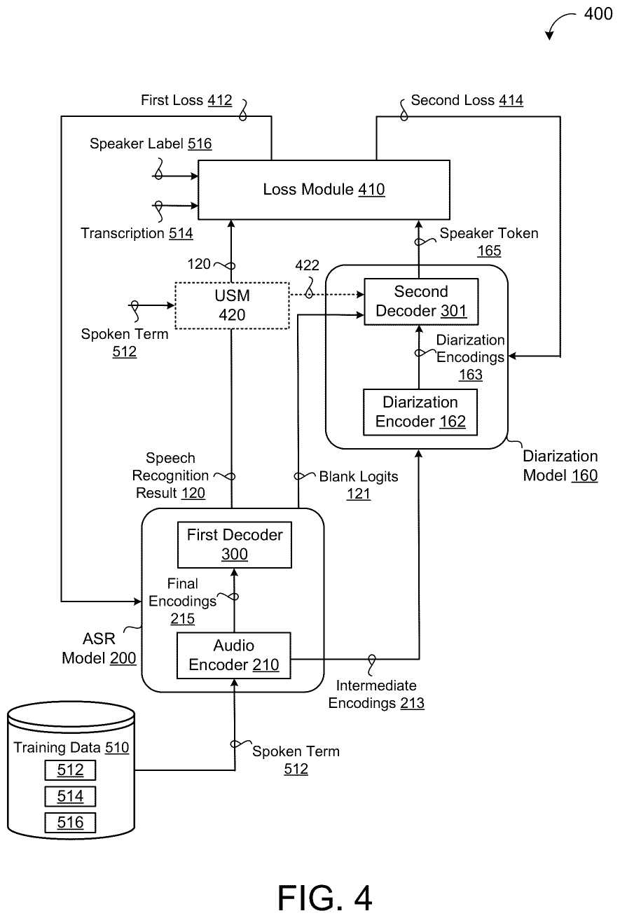

FIG. 4 illustrates an example training process 400 for training the joint speech recognition and speaker diarization model 150 (FIG. 1). In particular, the training process 400 trains the ASR model 200 jointly with the diarization model 160. In some examples, the training process 400 trains ASR model 200 by updating parameters of the ASR model 200 (e.g., parameters of the first decoder 300) based on a first loss 412 and trains the diarization model 160 by updating parameters of the diarization model 160 (e.g., parameters of the second decoder 301) based on a second loss 414. Thus, the first decoder 300 is trained to recognize terms spoken by the multiple speakers and the second decoder 301 is trained to predict/assign speaker tokens 165 for each spoken term.

In particular, the training process 400 obtains labeled training data 510 that includes a plurality of spoken terms (e.g., words, wordpieces, graphemes, etc.) 512 spoken during a conversation by two or more speakers. Here, each respective spoken term 512 may be characterized by a corresponding sequence of acoustic frames 108 (FIG. 1). Moreover, each respective spoken term 512 is paired with a corresponding transcription (e.g., ground-truth transcription) 514 of the respective spoken term (e.g., word, wordpiece, grapheme, etc.) and with a corresponding speaker label (e.g., ground-truth speaker token) 516 representing an identity of a speaker that spoke the respective spoken term 512 during the conversation. For each respective spoken term 512 of the plurality of spoken terms 512 from the labeled training data 510, the audio encoder 210 of the ASR model 200 generates (e.g., by the initial stack of the audio encoder layers 212 (FIG. 1)) a corresponding sequence of intermediate audio encodings 213 from the respective spoken term 512 and generates (e.g., by the remaining stack of the audio encoder layers 214 (FIG. 1)) a corresponding sequence of final audio encodings 215 from the corresponding intermediate audio encodings 213 for the respective spoken term 512. Thereafter, the first decoder 300 of the ASR model 200 generates a corresponding speech recognition result 120 based on the sequence of final audio encodings 215 generated by the audio encoder 210 for the respective spoken term 512. Moreover, the diarization encoder 162 of the diarization model 160 generates a corresponding sequence of diarization encodings 163 from the sequence of intermediate audio encodings 213 generated for the respective spoken term 512 and the second decoder 301 generates a respective speaker token 165 representing the predicted identity of the speaker 10 that spoke the respective spoken term 512.

The training process 400 includes a loss module 410 that determines the first loss 412 and the second loss 414 for training the ASR model 200 and the diarization model 160 of the joint speech recognition and speaker diarization model 150 (FIG. 1). In particular, the loss module 410 receives the speech recognition results 120 generated by the ASR model 200 for each spoken term 512 and the corresponding transcriptions 514, and determines the first loss (e.g., word error rate (WER) loss) 412 by comparing the speech recognition results 120 and the corresponding transcription 514 for each respective spoken term 512. In some examples, the training process 400 back-propagates the first loss 412 to the ASR model 200 and updates parameters of the ASR model 200 based on the first loss 412 determined for each respective spoken term 512 of the plurality of spoken terms 512 in the labeled training data 510.

In some implementations, the loss module 410 receives the speaker tokens 165 generated by the diarization model 160 for each respective spoken term 512 and the corresponding speaker labels 516, and determines the second loss (e.g., diarization loss) 414 by comparing the speaker tokens 165 with the corresponding speaker labels 516 for each of the spoken terms 512. In other implementations, the loss module 410 determines the second loss (e.g., word diarization error rate (WDER) loss) 414 according to:

$$WDER = \frac{{S}_{IS} + {C}_{IS}}{S + C} \qquad ( 1 )$$

In Equation 1, S_{IS} represents a number of speech recognition result substitutions with incorrect speaker tokens, C_{IS} represents a number of correct speech recognition results with incorrect speaker tokens, S represents a number of speech recognition result substitutions, and C represents a number of correct speech recognition results. The training process 400 may back-propagate the second loss 414 to the diarization model 160 and update parameters of the diarization model 160 based on the second loss 414 determined for each respective spoken term 512 of the plurality of spoken terms 512 from the labeled training data 510. Notably, the training process 400 trains the ASR model 200 based on the first loss 412 jointly with training the diarization model 160 based on the second loss 414.

Optionally, the training process 400 may include a universal speech model (USM) 420 (denoted by dotted lines). When the training process 400 does not include the USM the ASR model 200 outputs the speech recognition results 120 directly to the loss module 410. On the other hand, when the training process 400 includes the USM 420, the USM 420 receives each spoken term 512 from the training data 510 and the corresponding speech recognition results 120 generated by the ASR model 200. That is, because the ASR model 200 is being trained jointly with the diarization model 160 and the diarization model 160 only generates speaker tokens 165 when the ASR model 200 outputs non-blank speech recognition hypotheses 120, the training of the diarization model 160 may be degraded if the ASR model 200 misrecognizes the spoken terms 512 and/or generates a false-positive or false-negative speech recognition result. As such, the USM 420 is a high-quality pre-trained speech recognition model trained on one or more languages. The USM 420 supervises the ASR model 200 during training by receiving the speech recognition results 120 generated by the ASR model 200 and generating corresponding supervised speech recognition results 422 for the same spoken term 512. When the speech recognition results between the USM 420 and ASR model 200 match, the USM 420 outputs nothing. Otherwise, when the speech recognition results between the USM 420 and ASR model 200 fail to match, the USM 420 outputs the supervised speech recognition results 422 (including blank logits) to the diarization encoder 162 and the ASR model 200 still output the speech recognition results 120 to the loss module 410. Thus, the ASR model 200 still learns from the misrecognized speech recognition results 120 via the first loss 412 and the diarization model 160 receives accurate speech recognition results (e.g., the supervised speech recognition results 422) to avoid using noisy/incorrect training data.

In some scenarios, however, the amount of labeled training data needed for the training process 400 to train the joint speech recognition and speaker diarization model 150 is unavailable and/or expensive to obtain. In these scenarios, using a relatively small amount of labeled training data or using low-quality labeled training data leads to the joint speech recognition and diarization model having degraded performance during inference or overfitting the limited amount of training data. In particular, low-quality labeled training data may refer to training data that has misrecognized or missing terms from the conversation or has incorrect or missing speaker labels 516.

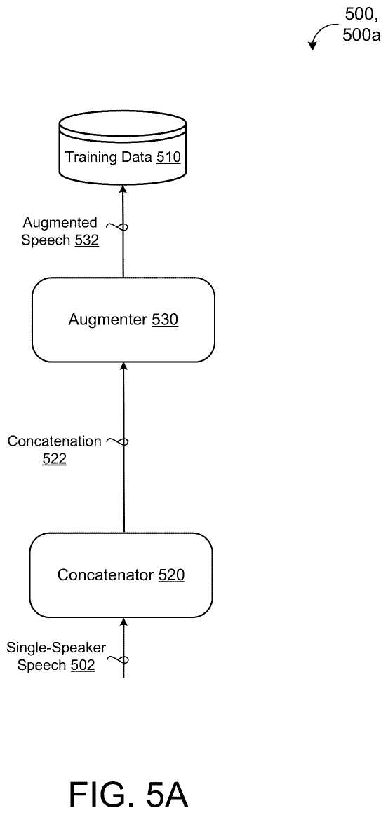

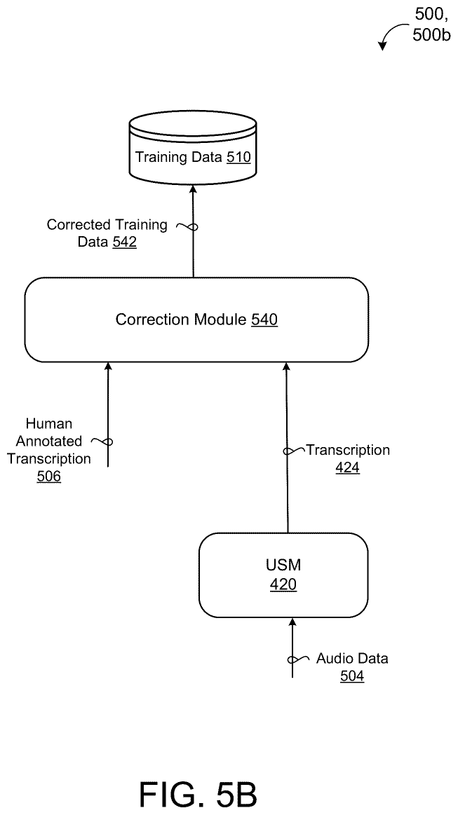

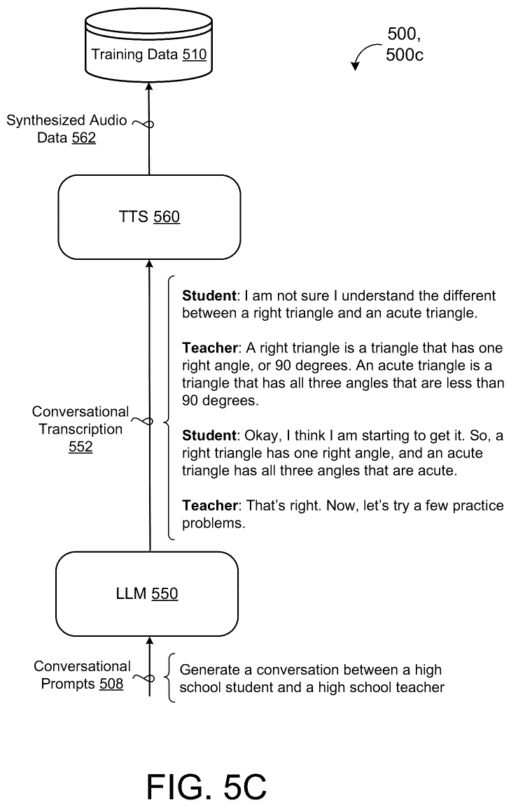

Referring now to FIGS. 5A-5C, to that end, an example data generation process 500 may generate and/or augment training data 510 that is used by the training process 400 (FIG. 4) to train the joint speech recognition and diarization model. The data generation process 500 includes a data augmentation part 500, 500a (FIG. 5A), a data correction part 500, 500b (FIG. 5B), and a data generation part 500, 500c (FIG. 5C). Thus, the training process 400 (FIG. 4) may use any combination of training data 510 generated by the data generation process 500 that supplements any available labeled training data 510 (e.g., human labeled training data).

Referring now to FIG. 5A, the data augmentation part 500a generates labeled training data 510 by obtaining a set of single-speaker speech segments 502 each including multiple speech segments from a single speaker. As such, the data augmentation part 500a is configured to generate diarization speech from the single-speaker speech 502. The single-speaker speech 502 includes a sampling of two or more speech segments from the single-speaker. For example, a first speech segment may include “How are you doing” and a second speech segment may include “I am doing well” both spoken by the same single-speaker. Thus, the data augmentation part 500a may include a concatenator 520 that receives single-speaker speech 502 and generate a concatenation 522 that combines the two speech segments. However, the concatenation 522 may sound unnatural at the transition between the two speech segments because the speech segments are not from an actual conversation, but instead, concatenated together.

To that end, the data augmentation part 500a employs an augmenter 530 configured to apply data augmentation to the concatenation 522 in order to make the concatenation 522 sound more like natural conversation. In particular, the data augmentation may include applying a silence or pause between the two speech segments concatenated together to generate augmented speech 532. Additionally or alternatively, the data augmentation may include applying cross-fade between the two speech segments. For instance, applying cross-fade may include fading-out the audio as the first speech segment ends and fading-in the audio as the second speech segment starts. Thus, the augmented speech 532 includes conversational speech by sampling speech from single-speaker speech 502 that sounds like natural speech between two or more speakers. The data augmentation part 500a adds the augmented speech 532 to the training data 510 for use during training (FIG. 4).

Referring now to FIG. 5B, in some implementations, the available labeled training data includes low-quality training data that is human-annotated. That is, the training data 510 may include transcriptions 514 that misrecognize, incorrectly add, or incorrectly delete spoken terms. Thus, the data correction part 500b may generate the labeled training data 510 by obtaining human annotated transcriptions 506 and corresponding audio data 504 and employing the USM 420 to correct the low-quality training data. Put another way, the data correction part 500b uses the USM 420 to generate high-quality labeled training data for multi-speaker datasets that have low-quality human labeled training data. Notably, each human annotated transcription 506 may include one or more incorrectly labeled terms. For example, the human annotated transcription 506 may include “<speaker: 1> how are u <speaker: 2> I'm doing well” where “<speaker: 1>” denotes a speaker token 165 of a first speaker speaking and “<speaker: 2>” denotes a speaker token 165 of a second speaker speaking. Notably, the human annotated transcription 506 includes the misspelling of “u.” The USM 420 is configured to receive the corresponding audio data 504 that corresponds to the human annotated transcription 506 and generate a corresponding transcription 424 without speaker tokens 165. Continuing with the above example, the USM 420 receives the corresponding audio data 504 and generates the transcription 424 of “how are you I'm doing well” that does not include any speaker tokens 165. Notably, the USM 420 correctly transcribed the term “you,” in contrast to the human annotated transcription 506.

The data correction part 500b also includes a correction module 540 configured to receive the human annotated transcription 506 and the transcription 424 generated by the USM 420 and generate, as output, corrected training data 542. In particular, the human annotated transcription 506 includes M number of terms and N number of speaker tokens 165 inserted before the transcription for each speaker and the transcription 424 includes K number of terms. Thus, the correction module 540 inserts the N number of speaker tokens 165 from the human annotated transcription 506 into the transcription 424 generated by the USM 420 to generate the corrected training data 542. In particular, the correction module 540 identifies the number of terms before and after each speaker token 165 from the human annotated transcription 506 and inserts speaker tokens 165 with the same number of terms before and after each speaker token 165. Again continuing with the above example, the correction module 540 outputs the corrected training data 542 includes “<speaker: 1> how are you <speaker: 2> I'm doing well.” Notably, the corrected training data 542 includes the corrected term “you” and the accurate speaker tokens 165. The data correction part 500b adds the corrected training data 542 to the training data 510 for use during training (FIG. 4)

Referring now to FIG. 5C, in some instances, there is insufficient labeled training data 510 for conversations with two or more participants. To that end, the data generation part 500c includes a pre-trained large language model (LLM) 550 that is trained to generate conversational transcriptions 552 representing conversations between two or more people based on a conversational prompt 508. For instance, in the example shown, the LLM 550 receives the conversational prompt 508 of “generate a conversation between a high school student and a high school teacher” and generates the conversational transcription 552 as shown in FIG. 5C. The conversational transcription 552 may include LLM-generated speaker labels indicating which speaker speaks each word of the conversational transcription 552. Advantageously, the LLM 550 is able to generate a plurality of conversational transcriptions 552 based on any conversational prompt 508 adding a vast amount of training data.

Thereafter, a pre-trained text-to-speech (TTS) model 560 receives the conversational transcription 552 as input and generates, as output, synthesized audio data 562 corresponding to the conversational transcription 552. In some examples, the TTS model 560 generates synthesized speech using a different respective voice profile for each LLM-generated speaker label. Thus, the synthesized audio data 562 sounds like a natural conversation between a teacher speaking with first speech characteristics and a student speaking with second speech characteristics. As a result, the synthesized audio data 562 includes natural sounding speech for a natural conversation generated by the LLM 550 generated from the conversational prompt 508. The data generation part 500c adds the synthesized audio data 562 to the training data 510.

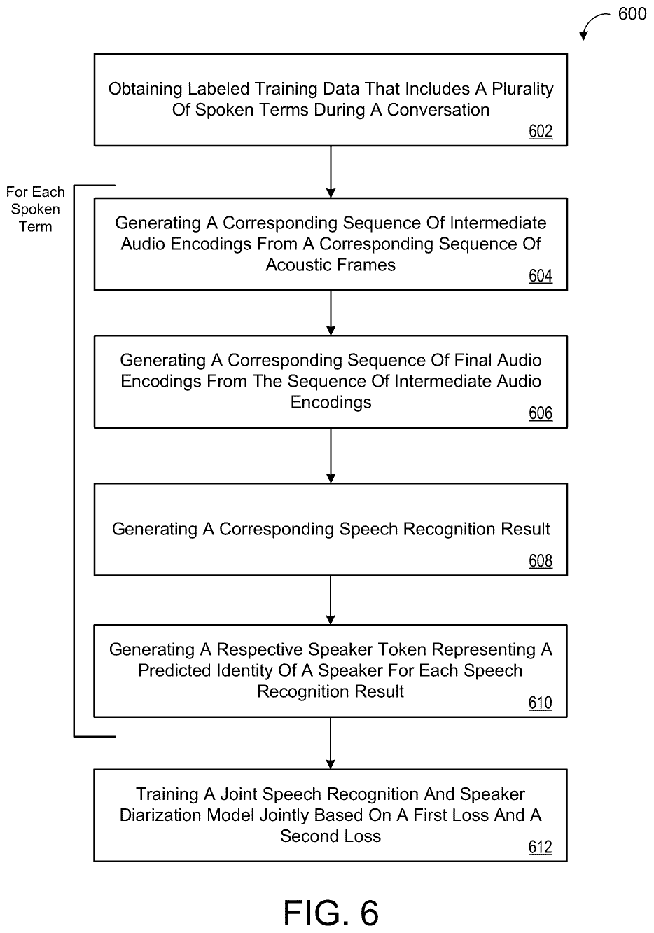

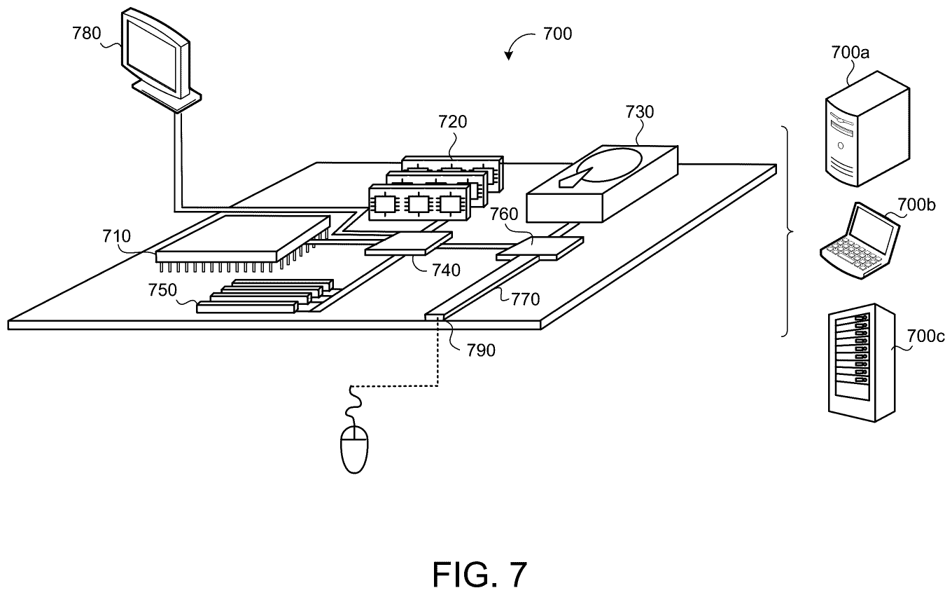

FIG. 6 includes a flowchart of an example arrangement of operations for a computer-implemented method of training a word-level end-to-end neural speaker diarization model with auxiliary networks. The method 600 may execute on data processing hardware 710 (FIG. 7) using instructions stored on memory hardware 720 (FIG. 7) that may reside on the user device 110 and/or the remote system 140 of FIG. 1 corresponding to a computing device 700 (FIG. 7).

At operation 602, the method 600 includes obtaining labeled training data 510 that includes a plurality of spoken terms 512 spoken during a conversation. Here, each respective spoken term 512 is characterized by a corresponding sequence of acoustic frames 108, and is paired with a corresponding transcription 514 of the respective spoken term 512 and a corresponding speaker label 516 representing an identity of a speaker 10 that spoke the respective spoken term 512 during the conversation. For each respective spoken term 512 of the plurality of spoken terms 512, the method 600 performs operations 604-610. At operation 604, the method 600 includes generating a corresponding sequence of intermediate audio encodings 213 from the corresponding sequence of acoustic frames 108 using an initial stack of audio encoder layers 212 of a joint speech recognition and speaker diarization model 150. At operation 606, the method 600 includes generating a corresponding sequence of final audio encodings 215 from the intermediate audio encodings 213 using a remaining stack of the audio encoder layers 214 of the joint speech recognition and speaker diarization model 150. At operation 608, the method 600 includes generating, as output from a second decoder 301 of the joint speech recognition and speaker diarization model 150, a corresponding speech recognition result 120 based on the sequence of final audio encodings 215. At operation 610, for each corresponding speech recognition speech recognition result 120 generated as output from the first decoder 300, the method 600 includes generating a respective speaker token 165 representing a predicted identity of the speaker 10. Here, a second decoder 301 of the joint speech recognition and speaker diarization model 150 generates the respective speaker token 165 as output. At operation 612, the method 600 includes training the joint speech recognition and speaker diarization model 150 based on a first loss 412 derived from the generated speech recognition results 120 and the corresponding transcriptions 514 and a second loss 414 derived from the generated speaker tokens 165 and the corresponding speaker labels 516.

FIG. 7 is a schematic view of an example computing device 700 that may be used to implement the systems and methods described in this document. The computing device 700 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 700 includes a processor 710, memory 720, a storage device 730, a high-speed interface/controller 740 connecting to the memory 720 and high-speed expansion ports 750, and a low speed interface/controller 760 connecting to a low speed bus 770 and a storage device 730. Each of the components 710, 720, 730, 740, 750, and 760, are interconnected using various busses, and may be mounted on a common motherboard or in other manners as appropriate. The processor 710 can process instructions for execution within the computing device 700, including instructions stored in the memory 720 or on the storage device 730 to display graphical information for a graphical user interface (GUI) on an external input/output device, such as display 780 coupled to high speed interface 740. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 720 stores information non-transitorily within the computing device 700. The memory 720 may be a computer-readable medium, a volatile memory unit(s), or non-volatile memory unit(s). The non-transitory memory 720 may be physical devices used to store programs (e.g., sequences of instructions) or data (e.g., program state information) on a temporary or permanent basis for use by the computing device 700. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 730 is capable of providing mass storage for the computing device 700. In some implementations, the storage device 730 is a computer-readable medium. In various different implementations, the storage device 730 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 720, the storage device 730, or memory on processor 710.

The high speed controller 740 manages bandwidth-intensive operations for the computing device 700, while the low speed controller 760 manages lower bandwidth-intensive operations. Such allocation of duties is exemplary only. In some implementations, the high-speed controller 740 is coupled to the memory 720, the display 780 (e.g., through a graphics processor or accelerator), and to the high-speed expansion ports 750, which may accept various expansion cards (not shown). In some implementations, the low-speed controller 760 is coupled to the storage device 730 and a low-speed expansion port 790. The low-speed expansion port 790, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 700a or multiple times in a group of such servers 700a, as a laptop computer 700b, or as part of a rack server system 700c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
obtaining labeled training data comprising a plurality of spoken terms spoken during a conversation, each respective spoken term characterized by a corresponding sequence of acoustic frames and paired with a corresponding transcription of the respective spoken term and a corresponding speaker label representing an identity of a speaker that spoke the respective spoken term during the conversation;
for each respective spoken term of the plurality of spoken terms:
generating, by an initial stack of audio encoder layers of a joint speech recognition and speaker diarization model, from the corresponding sequence of acoustic frames, a corresponding sequence of intermediate audio encodings;
generating, by a remaining stack of audio encoder layers of the joint speech recognition and speaker diarization model, from the corresponding sequence of intermediate audio encodings, a corresponding sequence of final audio encodings;
generating, as output from a first decoder of the joint speech recognition and speaker diarization model configured to receive the corresponding sequence of final audio encodings, a corresponding speech recognition result; and
for each corresponding speech recognition result generated as output from the first decoder, generating, as output from a second decoder of the joint speech recognition and speaker diarization model configured to receive the corresponding sequence of intermediate audio encodings, a respective speaker token representing a predicted identity of a speaker; and
training the joint speech recognition and speaker diarization model jointly based on a first loss derived from the generated speech recognition results and the corresponding transcriptions and a second loss derived from the generated speaker tokens and the corresponding speaker labels.

2. The computer-implemented method of claim 1, wherein the joint speech recognition and speaker diarization model comprises an automatic speech recognition (ASR) model and a diarization model.

3. The computer-implemented method of claim 2, wherein:
the ASR model comprises an audio encoder and the first decoder, the audio encoder comprising the initial stack of audio encoder layers and the remaining stack of audio encoder layers; and
the diarization model comprises a diarization encoder and the second decoder.

4. The computer-implemented method of claim 3, wherein the operations further comprise:
generating, by the diarization encoder, from the corresponding sequence of intermediate audio encodings, a corresponding sequence of final audio encodings,
wherein generating the respective speaker token representing the predicted identity of the speaker comprises generating the respective speaker token from the corresponding sequence of final audio encodings.

5. The computer-implemented method of claim 3, wherein the diarization encoder comprises a memory unit configured to store previously generated diarization encodings.

6. The computer-implemented method of claim 1, wherein:
the first decoder comprises a first joint network and a prediction network; and
the second decoder comprises a second joint network and the prediction network shared with the first decoder.

7. The computer-implemented method of claim 6, wherein each of the first joint network and the second joint network comprise:
a respective first projection layer;
a respective linear layer; and
a respective softmax layer.

8. The computer-implemented method of claim 1, wherein the respective speaker token comprises at least one of:
a word-level speaker token;
a wordpiece-level speaker token; and
a grapheme-level speaker token.

9. The computer-implemented method of claim 1, wherein the operations further comprise generating the labeled training data by:
obtaining a set of single-speaker speech segments;
concatenating two or more single-speaker speech segments from the set of single-speaker speech segments; and
augmenting the concatenated two or more single-speaker speech segments.

10. The computer-implemented method of claim 1, wherein the operations further comprise generating the labeled training data by:
obtaining a human annotated transcription and corresponding audio data, the human annotated transcription comprising speaker labels and one or more incorrectly labeled terms;
generating, using a universal speech model, a transcription for the corresponding audio data; and
replacing the one or more incorrectly labeled terms using the transcription generated by the universal speech model for the corresponding transcription.

11. The computer-implemented method of claim 1, wherein the operations further comprise generating the labeled training data by:
receiving a conversational prompt;
generating, by a pre-trained large language model (LLM), a conversational transcription based on the conversational prompt; and
synthesizing, using a pre-trained text-to-speech (TTS) model, the conversational transcription.

12. A system comprising:
data processing hardware; and
memory hardware in communication with the data processing hardware, the memory hardware storing instruction that when executed on the data processing hardware cause the data processing hardware to perform operations comprising:
obtaining labeled training data comprising a plurality of spoken terms spoken during a conversation, each respective spoken term characterized by a corresponding sequence of acoustic frames and paired with a corresponding transcription of the respective spoken term and a corresponding speaker label representing an identity of a speaker that spoke the respective spoken term during the conversation;
for each respective spoken term of the plurality of spoken terms:
generating, by an initial stack of audio encoder layers of a joint speech recognition and speaker diarization model, from the corresponding sequence of acoustic frames, a corresponding sequence of intermediate audio encodings;
generating, by a remaining stack of audio encoder layers of the joint speech recognition and speaker diarization model, from the corresponding sequence of intermediate audio encodings, a corresponding sequence of final audio encodings;
generating, as output from a first decoder of the joint speech recognition and speaker diarization model configured to receive the corresponding sequence of final audio encodings, a corresponding speech recognition result; and
for each corresponding speech recognition result generated as output from the first decoder, generating, as output from a second decoder of the joint speech recognition and speaker diarization model configured to receive the corresponding sequence of intermediate audio encodings, a respective speaker token representing a predicted identity of a speaker; and
training the joint speech recognition and speaker diarization model jointly based on a first loss derived from the generated speech recognition results and the corresponding transcriptions and a second loss derived from the generated speaker tokens and the corresponding speaker labels.

13. The system of claim 12, wherein the joint speech recognition and speaker diarization model comprises an automatic speech recognition (ASR) model and a diarization model.

14. The system of claim 13, wherein:
the ASR model comprises an audio encoder and the first decoder, the audio encoder comprising the initial stack of audio encoder layers and the remaining stack of audio encoder layers; and
the diarization model comprises a diarization encoder and the second decoder.

15. The system of claim 14, wherein the operations further comprise:
generating, by the diarization encoder, from the corresponding sequence of intermediate audio encodings, a corresponding sequence of diarization encodings,
wherein generating the respective speaker token representing the predicted identity of the speaker comprises generating the respective speaker token from the corresponding sequence of diarization encodings.

16. The system of claim 14, wherein the diarization encoder comprises a memory unit configured to store previously generated diarization encodings.

17. The system of claim 12, wherein:
the first decoder comprises a first joint network and a prediction network; and
the second decoder comprises a second joint network and the prediction network shared with the first decoder.

18. The system of claim 17, wherein each of the first joint network and the second joint network comprise:
a respective first projection layer;
a respective linear layer; and
a respective softmax layer.

19. The system of claim 12, wherein the respective speaker token comprises at least one of:
a word-level speaker token;
a wordpiece-level speaker token; and
a grapheme-level speaker token.

20. The system of claim 12, wherein the operations further comprise generating the labeled training data by:
obtaining a set of single-speaker speech segments;
concatenating two or more single-speaker speech segments from the set of single-speaker speech segments; and
augmenting the concatenated two or more single-speaker speech segments.

21. The system of claim 12, wherein the operations further comprise generating the labeled training data by:
obtaining a human annotated transcription and corresponding audio data, the human annotated transcription comprising speaker labels and one or more incorrectly labeled terms;
generating, using a universal speech model, a transcription for the corresponding audio data; and
replacing the one or more incorrectly labeled terms using the transcription generated by the universal speech model for the corresponding transcription.

22. The system of claim 12, wherein the operations further comprise generating the labeled training data by:
receiving a conversational prompt;
generating, by a pre-trained large language model (LLM), a conversational transcription based on the conversational prompt; and
synthesizing, using a pre-trained text-to-speech (TTS) model, the conversational transcription.
